(19) United States
(12) Patent Application Publication
(10) Pub. No.: US 2010/0248182 A1
(43) Pub. Date: Sep. 30, 2010

(54) Carbide bar for dental rotary instrument

(75) Inventors: Shuji Sonoi, Ashiya-shi (JP); Osamu Asao, Minamikawachi-gun (JP); Masako Shigezawa, Kyoto-shi (JP)

Correspondence Address: OLIFF & BERRIDGE, PLC, P.O. BOX 320850, ALEXANDRIA, VA, 22320-4850, US

(73) Assignee: SHOFU INC., Kyoto-Shi (JP)

(21) Appl. No.: 12/654,601

(22) Filed: Dec. 24, 2009

(30) Foreign Application Priority Data
Dec. 27, 2008 (JP) 2008-335442

(51) Int. Cl. A61C 3/06

(52) U.S. Cl. 433/166

(57) ABSTRACT

This invention discloses a carbide bar for a dental rotary instrument which eliminates defects of the prior art. In the prior art, blades of the carbide bar are twisting on to rightward from a bottom to a top portion and this twisting offers some inconvenience such as detaching connection between hand piece and the bar during rotation work and stacking of cutting dusts for ill efficiency. This invention has now developed a new method for the blades, which should be twisted leftward from the bottom to the top to clear the submitted inconvenience.

### RELATED APPLICATION

This present disclosure relates to subject matter contained in Japanese Patent Application Number 2008-335442. (filed on Dec. 27, 2008) which is expressly incorporation herein by reference in its entirety.

### BACKGROUND OF THE INVENTION

1. Field of the Invention

This invention relates to a carbide bar for a dental rotary instrument, wherein the bar is adopted for the dental instrument as a cutting and polishing tool for a dental artificial subject. Thus, the carbide bar is set to dental hand piece accordingly. This developed bar especially attains effective cutting and smooth polishing for dental materials such as plasters or plastics and eliminates prior defects accordingly.

2. Description of the Prior Art

A carbide bar is normally used in dental instrument and it is made of tungsten carbide as cutting portion while the carbide portion is adhered or waxed in chemical method onto a shank which is made by such as stainless bar, and then it is finished into a proper shape so that it can be used properly for the dental instrument. Then the shank is firmly screwed into the bottom handle of the hand piece. This carbide bar has good durability so that it may be used for cutting and polishing a wide range of dental materials such as plasters, ceramics, metals, and so on.

The carbide bar in general, as shown in FIG. 1, has plural blades which are twisted gradually rightward from a bottom to a top portion. When the bar is rotated in right turn same as a rotation work, the cutting and polishing is started. However, when some extra and big force is caused for the working procedure, the fastening force between the bar and the bottom hand piece is gradually to grow loose and finally it results for direction of de-screwing therebetween. Thus, it is worried that the carbide bar is fallen off from the hand piece, and it may cause some dangerous situation for the worker.

At the same time, in this prior art, while the cutting and polishing are performed, cutting dusts are caused and are unavoidably accumulated among the blades, and therefore this accumulation causes a problem for smooth cutting and polishing, and sometimes it is required to clear those dusts there from even during the working time. Especially for wet materials or else for water supply in the performing process, the dusts are increased among the blades, whereon the cutting efficiency is largely deteriorated.

The performing work in this prior art may also promote to scatter the dusts toward the worker, and thus the working efficiency is also badly influenced.

As explained in the prior art, it has some problems to be cleared to perform the cutting and polishing works. As the blades are twisted rightward from the bottom to the upward, the carbide bar is afraid to be loosened and to be fallen off from the hand piece during round rotation work, so that it may cause the dangerous situation for the user. Also, thus the caused dusts are unavoidably accumulated during cutting process among the blades, which may cause ill performance of the work in efficiency for cutting and polishing. At the same time, during these cutting and polishing process, these accumulated dusts are required to be cleared off because the situations may affect smooth process thereof. Especially for cutting wet materials or continuing the relative cutting work with water supplying, the dusts are increased among the blades. In order to clear this situation, the worker has to stop his continued work to clear them. Thus, the caused dusts might be scattered against the worker for low efficiency of the work.

### SUMMARY OF THE INVENTION

In view of explained defects, the present invention has been developed.

This invention has an object to provide a carbide bar for dental rotary instrument which can cut and polish dental materials smoothly with good efficiency in safe manners without inviting accumulated dusts too much. For this developed bar, it is now more required to attain smoother finish for the polishing surface than performing a great deal of cutting and polishing work.

This invention has now adopted the carbide bar with plural blades which are twisted gradually leftward from a bottom to a top portion, wherein loading force between the bar and the hand piece is always maintained against the operating rotation to keep the connection between the bar and the hand piece. At the same time, the caused dusts are reduced for depositing between the blades and are not scattered against the performing worker. By this adoption, the danger where the bar is loosened and departed from the hand piece is avoided while accumulation of dusts between the blades and scattering of the dusts toward the performing worker are also eliminated.

When preparing an artificial dental material, surface of the material should be produced as smooth as possible, and this smoothness attributes to adaptation feeling for an user of this material and also promotes to reduce adherence of oral plaque during actual use for the user. Thus the smooth finish for the material is necessary for using the submitted materials.

### BRIEF DESCRIPTION OF THE DRAWINGS

FIG. 1 is a front view of a carbide bar used in the prior art, wherein plural blades are twisted slightly and gradually rightward from a bottom to a top portion.

FIG. 2 is a front view of a carbide bar developed by the present invention, wherein plural blades are twisted leftward from the bottom to the top portion.

FIG. 3 is a front view of a carbide bar, showing a first embodiment developed by this invention.

FIG. 4 is a front view of a second embodiment for a carbide bar having the other shape of blades developed by the invention.

FIG. 5 is also a front view of a third embodiment for a carbide bar having another shape of blades developed by the present invention.

FIG. 6 is a plan view of top blades portion for the embodiment 1, wherein blade composition can be clearly seen by this invention.

### DESCRIPTION OF THE PREFERRED EMBODIMENTS

The preferred embodiments shall be explained below with Figures from 1 to 6, but prior to the explanation, we should like to emphasize below.

After various and actual experiments in trial and error manners, the following merits are found by the inventors. The number of the blades to be adopted in this invention should be composed of 6, 7 and 8. In theory, when the blades number is increased, the cut and polished surface become smoother, but the blades over the FIG. 8 pieces do not have enough gaps between the blades to incur the stacking of the caused dusts. Accordingly, the number of the blades to be 6, 7 and 8 is recommended. It is also recommended that the maximum pitch for the blades is between 2.0-2.5 mm should be adopted. With regard to the type of the blade, it is also recommended to adopt plane-cut type, not cross-cut type, because the cross-cut type blade may invite harsh surface.

The size for cutting and polishing portion is recommended to be 3-15 mm, preferably 10-15 mm. The diameter of the portion should be 3-10 mm. This diameter means the maximum size around the portion.

Form of the adopted carbide bar is optional, but it is now preferable to produce the form in a bullet type or a cylinder type as shown in the Figures.

As repeated, the numbers of the blades should be 6, 7 and 8.

The angle of the blade should be between 55°-80°, preferably 60°-75°.

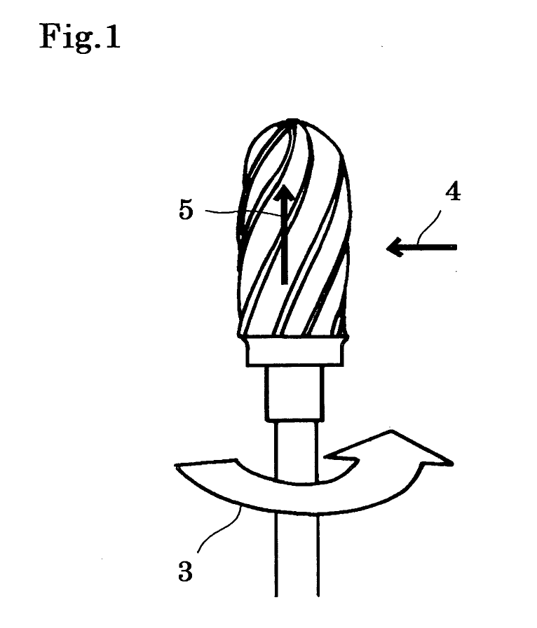

FIG. 1 is a front view of a carbide bar used in the prior art, wherein plural blades are twisted slightly rightward from a bottom to a top portion. A numeral 4 shows a loading force caused by cutting and polishing work, while the numeral 5 shows the force to be carried by the bar.

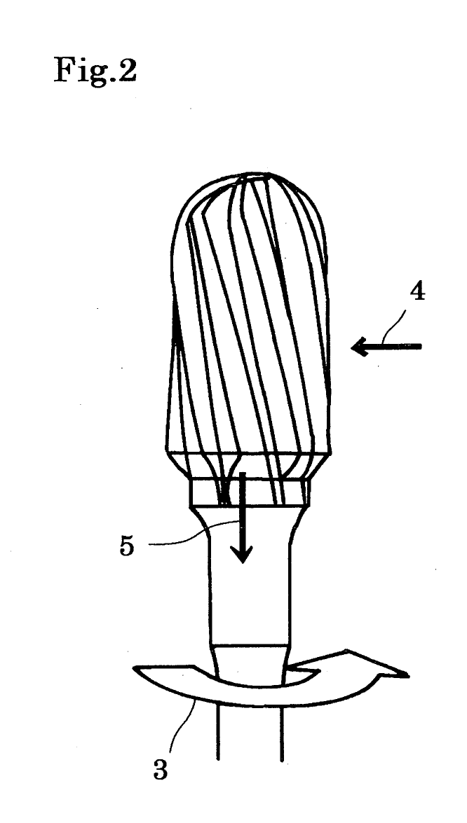

FIG. 2 shows a front view of the carbide bar developed by this invention, wherein plural blades are slightly twisted leftward from the bottom to the top portion.

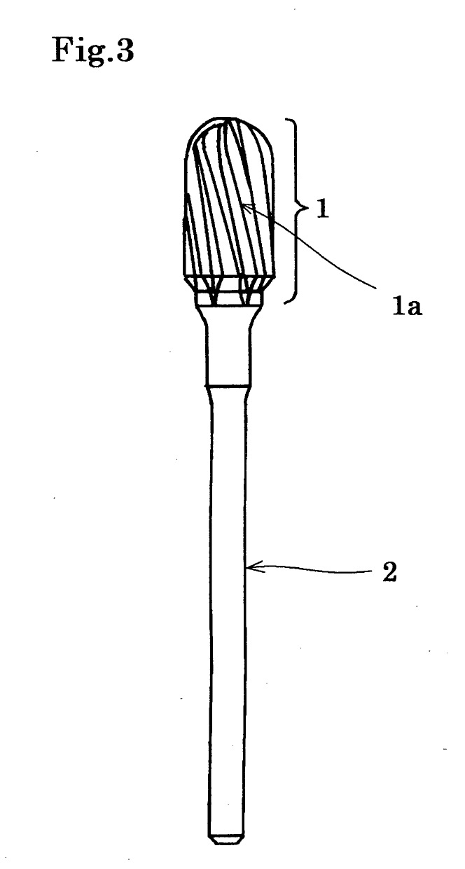

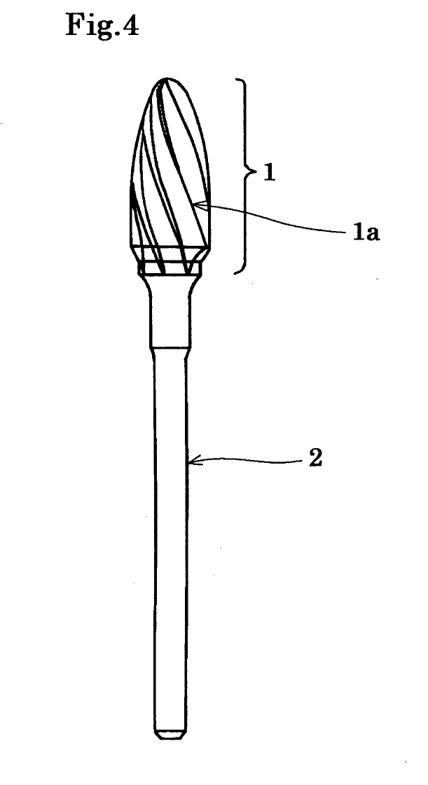

FIG. 3 and FIG. 4 are front views of the carbide bars developed by the present invention as Embodiment 1 and Embodiment 2, wherein the numeral 1 shows the cutting and polishing portion while the numeral 1a shows a blade while the numeral 2 shows a shank.

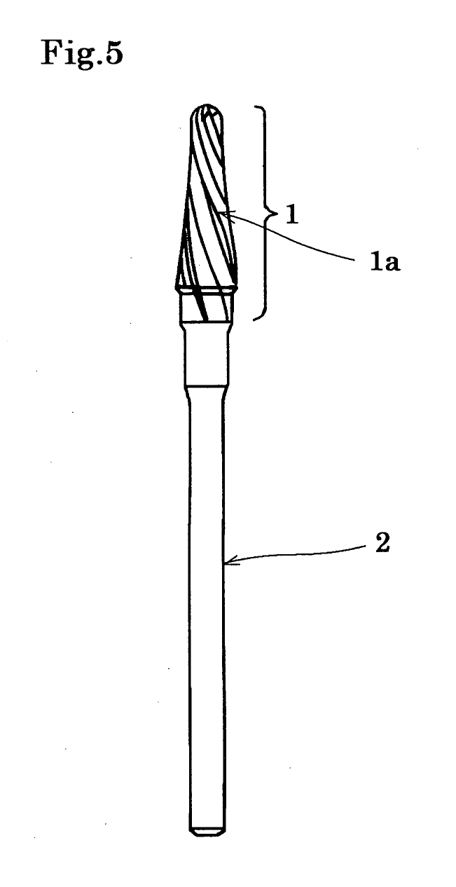

FIG. 5 is also the front view of Embodiment 3, wherein the other cylinder shape of the bar adopted and this cylinder shape is devised to be smaller toward top from the bottom like a conical form.

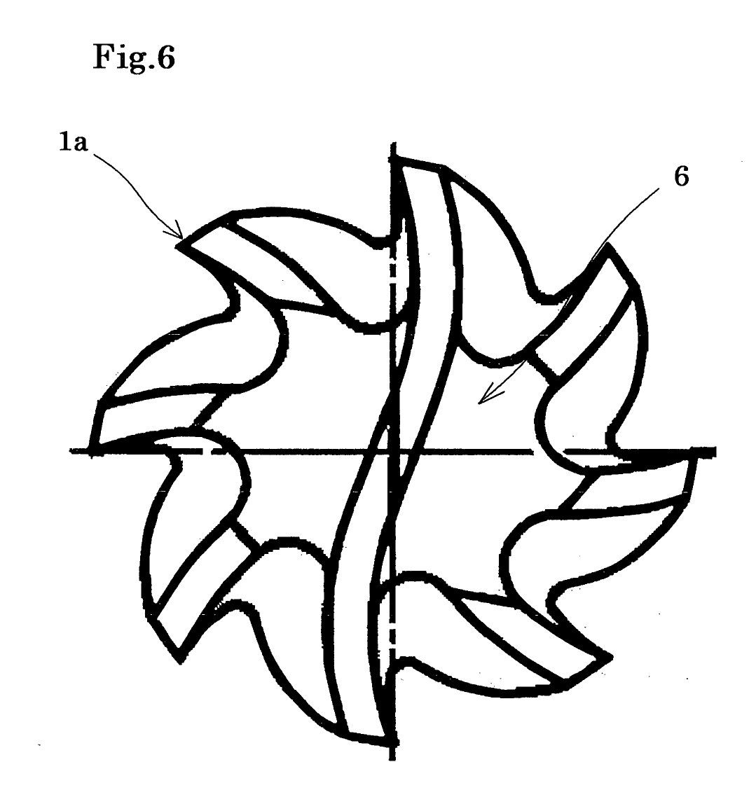

With reference to FIG. 6, it shows a plan view of a top portion for the cutting portion of the carbide bar, and this is the Embodiment 1 as above shown. A numeral 6 is the surface ditch of the blade. This cutting portion of the carbide bar should not be preferably as the blade in the tip end, and at this tip end a part of ditch portion should be formed. The ditch surface of this tip end should be preferably inclined at a angle against an axis, and further this blade tip should be formed in contrast angle to the center of the axis.

Now, the actual embodiments are performed. The Embodiment 1 (Emb.1) is performed with the cylinder type in FIG. 3, while the Embodiment 2 (Emb.2) is also performed with the bullet type in FIG. 4, where the blades are twisted leftward with adoption of 8 pieces and with the plane cut system. The experiment is now performed by the dental hand piece engine at 10,000 rpm, for 30 seconds, where a super hard plaster and an acryl plate are cut and polished for testing, and at the same time the super hard plaster in wet condition is also tested in the same condition for confirming the cut dust stacking. In this test, a comparison tests (Com.1, Com.2 and Com.3) are also performed in the conditions that Com.1 is equipped with leftward twisting blades in the same cylinder type adopting 4 pieces blades in the plane cut, and Com.2 with leftward twisting blades and with 4 pieces blades in the plane cut while Com.3 with rightward twisting blades and with 10 pieces blade in cross cut. This test results were now shall be produced in next pages in Table I and Table II as follows:

For these Tables, an abbreviation can be referred and used as below.

### Emb.1=Embodiment 1

### Emb.2=Embodiment 2

### Emb.3=Embodiment 3

### Com.1=Comparison Test 1

### Com.2=Comparison Test 2

### Com.3=Comparison Test 3

### Com.4=Comparison Test 4

### Com.5=Comparison Test 5

TABLE I

| | | Emb. 1 | Com. 1 |
|---|---|---|---|
| Form of bar | | cylinder | cylinder |
| Type of blade | | leftward | leftward |
| | | twisted | twisted |
| | | Plane cut | plane cut |
| Number of blades | | 8 pcs | 4 pcs |
| At the time | Cut Qty | 249 | 381 |
| of superhard | (mg) | | |
| plaster | Cut surface | 1.05 | 1.69 |
| | Ra(μm) | | |
| | Cut face | ◯ | X |
| | finish | | |
| | Stacking | ◯ | ◯ |
| | of dusts | | |

For the Tables including Table I, II and III, the marks “◯” and “X” means as follows
Mark ◯: Satisfactory results obtained.
Mark X: Unsatisfactory results obtained.

TABLE II

| | | Emb. 2 | Com. 2 | Com. 3 |
|---|---|---|---|---|
| Form of bar | | bullet | bullet | bullet |
| Type of blade | | leftward | leftward | rightward |
| | | twisted | twisted | twisted |
| | | plane cut | plane cut | plane cut |
| Number of blades | | 8 pcs | 4 pcs | 10 pcs |
| At the time | Cut Qty | 289 | 320 | 191 |
| of superhard | (mg) | | | |
| plaster | Cut surface | 1.00 | 2.03 | 1.85 |
| cutting | Ra(μm) | | | |
| | Cut face | ◯ | X | X |
| | finish | | | |
| | Stacking | ◯ | ◯ | X |
| | of dusts | | | |

On checking the above Table I and Table II, we should like to explain the results of the same. With regard to Table I, our Embodiment 1 method is a little bit inferior to the Comparison test 1 in the cut quantity, but the difference is very small and acceptable. The each cut quantity shows some difference in accordance with the number of blades, but Embodiment 1 is still satisfactory. The cut surface of Embodiment 1 is much better than Comparison Test 1, while the cut face finish is in Embodiment 1 is also better than Comparison Test 1. With regard to the stacking of dusts, both Embodiment and Comparison Test are all right.

With regard to our Embodiment 2, when we check and observe this Table 2 with comparison Test 2 and 3, we can obtain the satisfactory and similar results accordingly similar to our Table I. We also observe we can attain satisfactory condition for the stacking of the dusts even if the cutting is performed in the wet condition.

TABLE III

| | | Emb. 3 | Com. 4 | Com. 5 |
|---|---|---|---|---|
| Type of blade | | Leftward | Rightward | Rightward |
| | | twisted | twisted | twisted |
| | | plane cut | cross cut | plane cut |
| Number of Blades | | 6 pcs | 12 pcs | 12 pcs |
| At the time | Cut Qty | 57 | 50 | 44 |
| of acryl plate | (mg) | | | |
| cutting | Cut surface | 1.37 | 1.67 | 1.52 |
| | Ra(μm) | | | |
| | Cut face | ◯ | X | X |
| | finish | | | |
| | Stacking | ◯ | X | X |
| | of dusts | | | |

When we check and compare our Embodiment 3 with the comparison tests 4 and 5 in this Table III with the acryl plate cutting performance, we also find satisfactory results for all points. Now, under our deep study and observation for the three tables as represented and performed comparisons in our developed carbide bars with prior bars, we have obtained satisfactory results. We are now in a position to provide our developed carbide bar for the dental rotary instruments, whereas we may submit the fine machines, namely the carbide bar for the dental rotary instruments and by this machine submission, the field workers and also the patients can enjoy the same in good efficient manners and in good feeling in the dental world.

It is further understood by those skilled in the art that the foregoing description is preferred embodiment of the disclosed method and that various changes and modifications may be made in this invention without departing from the sprit and scope thereof.

What is claimed is:

1. A carbide bar for a dental rotary machine to be attached with a hand piece for dental workers, and the bar comprises: a stick type shank made of stainless steel;
cutting portions prepared at one end of the shank;
and the portions mainly made of tungsten carbide,
wherein the cutting portions have plural blades and the blades are composed of twisting form from the shank to a top portion in a contrary direction toward a rotary movement of the bar.

2. The carbide bar according to claim 1, wherein the blades are formed with 6, 7 or 8 pieces around on a top portion in equal intervals.

3. The carbide bar according to claim 1, wherein the blades are plain cut and maximum pitch between their mutual tips is 2.0˜2.5 mm.

4. The carbide bar according to claim 1, wherein the angle of the blades is 55°˜80°.

5. The carbide bar according to claim 1, wherein an inner angle of scooping for the blade is 0°˜20° while an outer angle of escaping for the blade is 5°˜20°.
